(19) United States
(12) Patent Application Publication
(10) Pub. No.: US 2019/0023292 A1
(43) Pub. Date: Jan. 24, 2019

(54) ONBOARD SYSTEM, GROUND SYSTEM, AND INFORMATION TRANSMISSION SYSTEM

(71) Applicants: KYOSAN ELECTRIC MFG. CO., LTD., Yokohama-shi (JP); Social System Development Laboratory Co., Ltd., Tokyo (JP)

(72) Inventors: Akira ASANO, Yokohama-shi (JP); Yuichirou SHIMIZU, Yokohama-shi (JP); Tomonori ITAGAKI, Kawasaki-shi (JP); Tetsuya TAKATA, Naka-gun (JP); Hideo NAKAMURA, Tokyo (JP)

(21) Appl. No.: 16/034,443

(22) Filed: Jul. 13, 2018

(30) Foreign Application Priority Data
Jul. 18, 2017 (JP) 2017-139122

(51) Int. Cl. B61L 15/00; B61L 27/00; H01Q 1/32

(52) U.S. Cl. CPC B61L 15/0027; B61L 2205/00; H01Q 1/3225; B61L 27/0005

(57) ABSTRACT

An information transmission system includes a ground system provided to a track and an onboard system installed in a train. The ground system includes two (M=2) track antennae selected from N types of track antennae with different resonance frequencies. The two track antennae are arranged side by side in a left and right direction relative to a traveling direction of the train. When the train passes through a position where the ground system is provided, the onboard system detects the two track antennae at once and can determine the resonance frequencies of the track antennae.

The content of Japanese Patent Application No. 2017-139122 filed on Jul. 18, 2017 is incorporated herein by reference.

### BACKGROUND

Automatic train stop (ATS) systems currently in practical use can be roughly classified into a frequency shift type ATS and a transponder based ATS, on the basis of the structure of a track antenna. The frequency shift type ATS system uses a track antenna having a resonance circuit and an onboard antenna emitting a predetermined frequency signal. Specifically, shifting of the signal frequency of the onboard antenna to the resonance frequency of the track antenna is detected. The onboard system performs traveling control on the basis of the detected resonance frequency, by referring to a database stored in advance (see, for example, JP-A-2013-021745).

In conventional frequency shift type ATS systems, only a single track antenna has been provided to a single track antenna installed position. Thus, the type of information that can be transmitted to the onboard system at a single track antenna installed position depends on the number of types of possible resonance frequencies of the track antenna. Logically, the types of information that can be transmitted can be increased by increasing the types of the track antenna (resonance frequencies). The types of information that can be transmitted can also be increased without increasing the types of track antennae, for example, with a combination of the resonance frequencies of a plurality of track antennae, arranged at a predetermined interval along a railway track direction, regarded as a single piece of information. In this method, however, each time a track antenna is detected by the onboard system, it is required to determine whether or not the information transmission is completed with the detected track antenna alone, or whether or not the information transmission involving a previously detected track antenna has not been completed yet because another track antenna will be detected later as a part of the combination to complete the information transmission. Furthermore, a plurality of track antennae to be a single combination need to be detected one by one, and thus it takes time to complete the detection for all the antennae.

### SUMMARY

According to the first aspect of the invention, there is provided an onboard system installed in a train that travels along a track, the track having a track antenna installed position where M types of track antennae selected from N types of track antennae with different resonance frequencies are arranged side by side in a left and right direction relative to a traveling direction or arranged to be entirely or partially overlap with each other in a vertical direction, N being larger than M, M being equal to or larger than 2, the onboard system comprising:

a transmission control section causing an onboard antenna to transmit a predetermined signal, the onboard antenna generating frequency signals corresponding to a resonance frequency of the track antennae when the onboard antenna and the track antennae resonate;

a determination section determining the M types of track antennae at the track antenna installed position, on the basis of the frequency signals generated in the onboard antenna when the train passes through the track antenna installed position; and

a traveling control section performing traveling control for the train on the basis of a determination result obtained by the determination section.

According to the second aspect of the invention, there is provided a ground system provided to a track along which a train including the onboard system travels, the ground system comprising

M types of track antennae selected from N types of track antennae with different resonance frequencies, N being larger than M, M being equal to or larger than 2,

the M types of track antennae being arranged side by side in a left and right direction relative to a traveling direction of the train or arranged to be partially or entirely overlapped with each other in a vertical direction.

A third aspect of the present invention is an information transmission system comprising: the onboard system described above; and a ground system including M types of track antennae selected from N types of track antennae with different resonance frequencies, N being larger than M, M being equal to or larger than 2, the M types of track antennae being arranged side by side in a left and right direction relative to a traveling direction of the train or arranged to be partially or entirely overlapped with each other in a vertical direction.

### BRIEF DESCRIPTION OF THE DRAWINGS

FIG. 1 is a diagram illustrating a configuration of an information transmission system.

FIG. 2 illustrates an example of how a ground system is installed.

FIG. 3 is a diagram illustrating functional configurations of an onboard system.

### DESCRIPTION OF EXEMPLARY EMBODIMENTS

The present embodiment can provide a technique suitable for increasing the types of information transmitted from a track antenna to an onboard system, without increasing the types of the track antennae.

According to one embodiment of the invention, there is provided an onboard system installed in a train that travels along a track, the track having a track antenna installed position where M types of track antennae selected from N types of track antennae with different resonance frequencies are arranged side by side in a left and right direction relative to a traveling direction or arranged to be entirely or partially overlap with each other in a vertical direction, N being larger than M, M being equal to or larger than 2, the onboard system comprising:

a transmission control section causing an onboard antenna to transmit a predetermined signal, the onboard antenna generating frequency signals corresponding to a resonance frequency of the track antennae when the onboard antenna and the track antennae resonate;

a determination section determining the M types of track antennae at the track antenna installed position, on the basis of the frequency signals generated in the onboard antenna when the train passes through the track antenna installed position; and

a traveling control section performing traveling control for the train on the basis of a determination result obtained by the determination section.

With this configuration, the M types of track antennae at the track antenna installed position are arranged side by side in the left and right direction relative to the traveling direction or arranged to be partially or entirely overlapped with each other in the vertical direction. Thus, the onboard system can detect the M types of track antennae at once, and determine their resonance frequencies. If a combination of the M types of resonance frequencies detected/determined at once is regarded as a single piece of information, a wider range of information can be transmitted to the onboard system from the ground system than in a case where a single track antenna is provided at the track antenna installed position.

In one of the above onboard systems,

the determination section may perform
calculating a Q factor of each of the N types of resonance frequencies on the basis of the frequency signal, and
determining the M types of track antennae at the track antenna installed position, on the basis of a resonance frequency corresponding to the Q factor satisfying a predetermined threshold condition.

With this configuration, the resonance frequency can be accurately determined by using the Q factor. For example, the resonance frequency of a track antenna can also be determined by using a resonance level. However, the resonance level is affected by swinging of a vehicle body and noise. The determination using the Q factor is not affected by the swinging of the vehicle body or noise, and thus can achieve more accurate determination of the resonance frequency than in the case where the resonance level is used.

According to another embodiment of the invention, there is provided a ground system provided to a track along which a train including one of the above onboard systems travels, the ground system may comprise

M types of track antennae selected from N types of track antennae with different resonance frequencies, N being larger than M, M being equal to or larger than 2,

the M types of track antennae being arranged side by side in a left and right direction relative to a traveling direction of the train or arranged to be partially or entirely overlapped with each other in a vertical direction.

According to another embodiment of the invention, there is provided an information transmission system comprising:

one of the above onboard systems; and

a ground system including M types of track antennae selected from N types of track antennae with different resonance frequencies, N being larger than M, M being equal to or larger than 2, the M types of track antennae being arranged side by side in a left and right direction relative to a traveling direction of the train or arranged to be partially or entirely overlapped with each other in a vertical direction.

### [System]

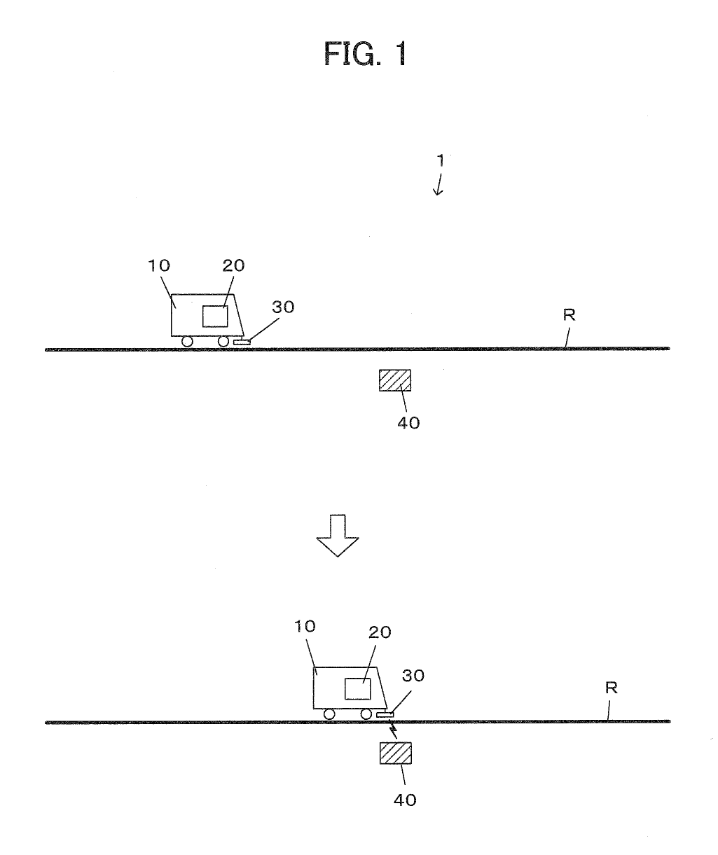

FIG. 1 is a diagram illustrating a configuration of an information transmission system 1 according to the present embodiment. The information transmission system 1 illustrated in FIG. 1 includes an onboard system 20 installed in a train 10 that travels along a track R and a ground system 40 provided along the track R. When the train 10 passes through the position where the ground system 40 is provided, the ground system 40 transmits information to the onboard system 20. The present embodiment is described with the train 10 serving as a vehicle that travels on rails provided along the track R. Note that a guideway may be provided along the track R if the vehicle travels on rubber tires or the like.

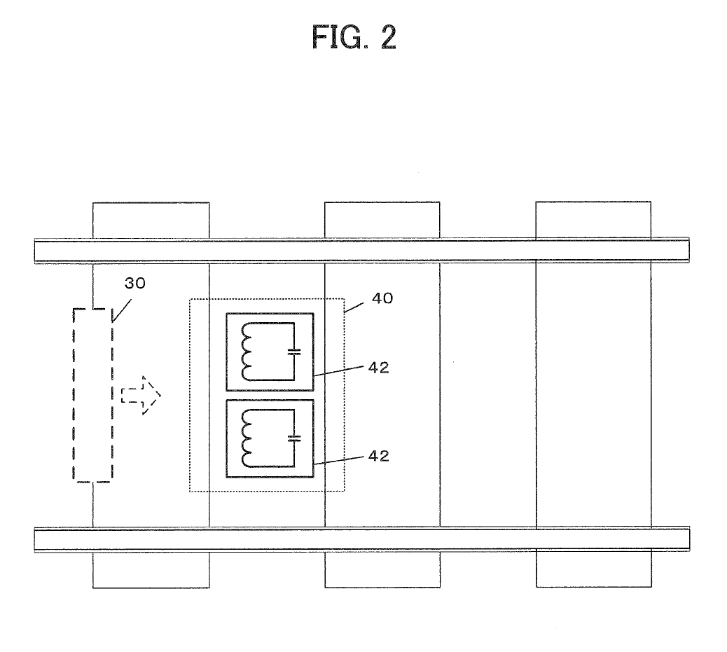

The ground system 40 includes two (M=2) track antennae 42 formed of resonant circuits with different resonance frequencies each selected from N types (N≥3) of different resonance frequencies. FIG. 2 illustrates an example of how the track antennae 42 are installed. As illustrated in FIG. 2, the two track antennae 42 of the ground system 40 are arranged side by side in a left and right direction (in a direction along a railroad tie between the rails in the present embodiment) relative to a traveling direction. When the train 10 passes through the installed position of the ground system 40, an onboard antenna 30, provided on a vehicle lower portion of the train 10, and the track antennae 42 are electromagnetically coupled to each other, so that the onboard system 20 of the train 10 can detect the two track antennae 42 at once. The two track antennae 42 can be arranged to be equally distant from the onboard antenna 30 to achieve substantially the same response characteristics.

The onboard system 20 “detects” the track antennae 42 by determining the resonance frequencies of the track antennae 42 on the basis of a signal (a frequency signal generated on the basis of the resonance frequencies of the track antennae) generated by the onboard antenna 30 as a result of electromagnetically coupling with the track antennae 42. The onboard system 20 can discriminate among the N types of resonance frequencies, and stores therein a code information table 114 in which a code information is associated with each possible combination between two types of the resonance frequencies. The onboard system 20 controls the train on the basis of code information associated with a combination of the resonance frequencies of the track antennae 42 detected at once. Thus, in the information transmission system 1, an information code is transmitted from the ground system 40 to the onboard system 20, on the basis of the combination of the resonance frequencies of the two track antennae 42 of the ground system 40.

The onboard system 20 determines the resonance frequencies of the track antennae 42 by using a Q factor. The Q factor, which may be calculated in any suitable way, is obtained from a current (onboard antenna current) of the onboard antenna 30 in the present embodiment. More specifically, the onboard antenna 30 transmits (emits) a composite signal obtained by combining N types of resonance frequencies fᵢ₀ (i=1, . . . , N) with cutoff frequencies f_{id} (i=1, . . . , N) respectively corresponding to the resonance frequencies fᵢ₀ (i=1, . . . , N). Then, a current (onboard antenna current) I of the onboard antenna 30 is calculated to determine a resonance frequency fₐ₀ and a resonance frequency f_{b0} respectively corresponding to a current Iₐ₀ and a current I_{b0} that are the highest and the second highest ones of onboard antenna currents Iᵢ₀ (i=1, . . . , N) respectively corresponding to the resonance frequencies fᵢ₀ (i=1, . . . , N). Then, the Q factor is calculated for each of the two resonance frequencies fₐ₀ and f_{b0}, from cutoff frequencies f_{ad} and f_{bd} respectively corresponding to the resonance frequencies fₐ₀ and f_{b0}, onboard antenna currents Iₐ₀ and I_{b0} respectively corresponding to the resonance frequencies fₐ₀ and f_{b0}, and onboard antenna currents I_{ad} and I_{bd} respectively corresponding to the cutoff frequencies f_{ad} and f_{bd}, on the basis of the following Formula (1):

Q=|fₘ₀/2(fₘ₀−f_{md})|\sqrt{2(Iₘ₀/I_{md})²−1} [Formula 1]

According to Formula (1), the Q factor can be obtained for the track antenna 42 on the basis of a resonance frequency fₘ₀ of the track antenna 42, a cutoff frequency f_{md}, an onboard antenna current Iₘ₀ corresponding to the resonance frequency fₘ₀, and an onboard antenna current I_{md} corresponding to the cutoff frequency f_{md}. The track antennae 42 with the resonance frequencies fₐ₀ and f_{b0} are determined to have been detected when the Q factor of each of the two resonance frequencies fₐ₀ and f_{b0} exceeds a predetermined threshold.

### [Functional Configuration]

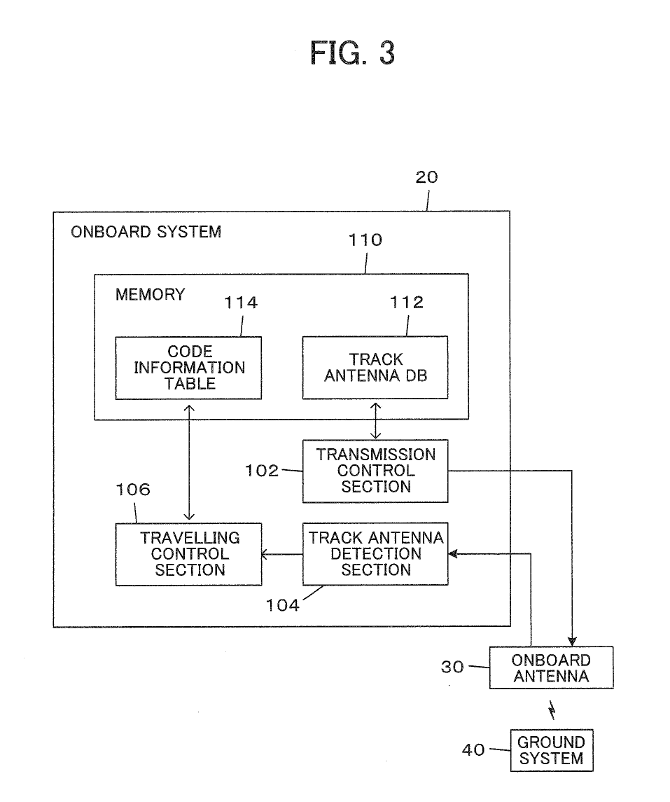

FIG. 3 is a diagram illustrating a configuration in the onboard system 20. As illustrated in FIG. 3, the onboard system 20 includes a processor and a memory 110 serving as a storage section and the like. The processor includes a central processing unit (CPU), an application specific integrated circuit (ASIC), a field-programmable gate array (FPGA), and the like. The storage section includes a random access memory (RAM), a read only memory (ROM), and the like. The track antennae 42 through which the train 10 has passed are detected and traveling control is performed on the basis of a result of the detection, with a program stored in the memory 110 executed. Functional sections implemented when the program is executed include a transmission control section 102, a track antenna detection section 104, and a traveling control section 106. The onboard system 20 further includes unillustrated functions such as a display section including a display, a light emitting diode, and the like, an operation section for performing a setting operation, and a communication section in charge of communicating with the external.

The transmission control section 102 generates the composite signal obtained by combining the N types of resonance frequencies fᵢ₀ (i=1, . . . , N) with the cutoff frequencies f_{id} (i=1, . . . , N) respectively corresponding to the resonance frequencies fᵢ₀ (i=1, . . . , N). The composite signal thus generated is constantly emitted from the onboard antenna 30. The N types of resonance frequencies fᵢ₀ (i=1, . . . , N) are resonance frequencies of the track antennae 42 that may be arranged along the track R, and can be determined by referring to a track antenna DB 112 in the memory 110. For each of the track antennae 42 arranged as described above, the installed position, the resonance frequency, and the like are stored in the track antenna DB 112 while being associated with each other.

The track antenna detection section 104 measures the current (onboard antenna current) of the onboard antenna 30, and uses the onboard antenna current to detect that the train 10 has passed through the track antenna 42 and to determine the resonance frequency of each of the two track antennae 42 detected at once. More specifically, the resonance frequency fₐ₀ and the resonance frequency f_{b0} respectively corresponding to the current Iₐ₀ and the current I_{b0} that are the highest and the second highest ones of the onboard antenna currents I_{b0} (i=1, . . . , N) respectively corresponding to the N types of resonance frequencies fᵢ₀ (i=1, . . . , N) are determined. Then, the Q factor is calculated for each of the two resonance frequencies fₐ₀ and f_{b0}, from the cutoff frequencies f_{ad} and f_{bd} respectively corresponding to the resonance frequencies fₐ₀ and f_{b0}, the onboard antenna currents Iₐ₀ and I_{b0} respectively corresponding to the resonance frequencies fₐ₀ and f_{b0}, and the onboard antenna currents I_{ad} and I_{bd} respectively corresponding to the cutoff frequencies f_{ad} and f_{bd}, on the basis of Formula (1). The track antennae 42 with the resonance frequencies fₐ₀ and f_{b0} are determined to have been detected when the Q factor of each of the two resonance frequencies fₐ₀ and f_{b0} exceeds a predetermined threshold.

The traveling control section 106 performs the traveling control for the train on the basis of the code information corresponding to the combination of the resonance frequencies of the track antennae 42 detected/determined by the track antenna detection section 104 by referring to the code information table 114 of the memory 110.

### Advantageous Effects

As described above, in the information transmission system 1 according to the present embodiment, the two (M=2) track antennae 42, selected as the two track antennae 42 forming a single ground system 40 from the N types of track antennae with different resonance frequencies, are arranged side by side in the left and right direction relative to the traveling direction. Thus, the onboard system 20 can detect the two track antennae 42 at once, and determine the resonance frequencies of the track antennae 42. Here, N×(N−1)/2 types of code information can be transmitted, with a combination of the two types of resonance frequencies detected/determined at once regarded as a single piece of information. Thus, a wider range of information can be transmitted to the onboard system 20 than in a case where a single track antenna is provided.

The determination on the resonance frequencies of the track antenna 42 by the onboard system 20 is based on the Q factor so as not to be affected by swinging of the vehicle body or noise. Thus, higher detection performance can be achieved for the track antenna 42. Furthermore, the track antenna 42 can be downsized, so that the two track antennae 42 can be arranged side by side between the left and right rails.

The invention is not limited to the above embodiments. Various modifications and variations may be made without departing from the scope of the invention.

### (A) Arrangement of the Track Antennae

The two track antennae of the ground system may be arranged to be partially or entirely overlapped with each other in a vertical direction (upper and lower direction) instead of being arranged side by side in the left and right direction relative to the traveling direction.

### (B) The Number M of the Track Antennae of the Ground System

A single ground system 40 may include three or more (M≥3) track antennae 42 with different resonance frequencies. The three or more track antennae 42 may be arranged side by side in the left and right direction relative to the traveling direction, or may be arranged to be partially or entirely overlapped with each other in the vertical direction. The track antenna detection section 104 of the onboard system 20 determines whether the predetermined threshold is exceeded by the Q factor corresponding to each of the three highest onboard antenna currents in the onboard antenna currents Iᵢ₀ (i=1, . . . , N) respectively corresponding to the N types of resonance frequencies fᵢ₀ (i=1, . . . , N), to determine whether or not the track antennae 32 with the three resonance frequencies are detected.

### (C) The Ground System can Include any Number of Ground Antennae

A single ground system 40 may include any number of track antennae 42 with different resonance frequencies (for example, one ground system may include a track antenna with a single resonance frequency, while another ground system includes two track antennae with different resonance frequencies).

In such a case, the track antenna detection section 104 of the onboard system 20 may determine whether or not the predetermined threshold is exceeded by the Q factor corresponding to each of the onboard antenna currents Iᵢ₀ (i=1, . . . , N) respectively corresponding to the N types of resonance frequencies fᵢ₀ (i=1, . . . , N), and may determine that the antennae with all the resonance frequencies corresponding to the onboard antenna currents corresponding to the Q factor exceeding the predetermined threshold are detected.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. An onboard system installed in a train that travels along a track, the track having a track antenna installed position where M types of track antennae selected from N types of track antennae with different resonance frequencies are arranged side by side in a left and right direction relative to a traveling direction or arranged to be entirely or partially overlap with each other in a vertical direction, N being larger than M, M being equal to or larger than 2, the onboard system comprising:
a transmission control section causing an onboard antenna to transmit a predetermined signal, the onboard antenna generating frequency signals corresponding to a resonance frequency of the track antennae when the onboard antenna and the track antennae resonate;
a determination section determining the M types of track antennae at the track antenna installed position, on the basis of the frequency signals generated in the onboard antenna when the train passes through the track antenna installed position; and
a traveling control section performing traveling control for the train on the basis of a determination result obtained by the determination section.

2. The onboard system as defined in claim 1,
the determination section performing
calculating a Q factor of each of the N types of resonance frequencies on the basis of the frequency signal, and
determining the M types of track antennae at the track antenna installed position, on the basis of a resonance frequency corresponding to the Q factor satisfying a predetermined threshold condition.

3. A ground system provided to a track along which a train including the onboard system according to claim 1 travels, the ground system comprising
M types of track antennae selected from N types of track antennae with different resonance frequencies, N being larger than M, M being equal to or larger than 2,
the M types of track antennae being arranged side by side in a left and right direction relative to a traveling direction of the train or arranged to be partially or entirely overlapped with each other in a vertical direction.

4. A ground system provided to a track along which a train including the onboard system according to claim 2 travels, the ground system comprising
M types of track antennae selected from N types of track antennae with different resonance frequencies, N being larger than M, M being equal to or larger than 2,
the M types of track antennae being arranged side by side in a left and right direction relative to a traveling direction of the train or arranged to be partially or entirely overlapped with each other in a vertical direction.

5. An information transmission system comprising:
the onboard system according to claim 1; and
a ground system including M types of track antennae selected from N types of track antennae with different resonance frequencies, N being larger than M, M being equal to or larger than 2, the M types of track antennae being arranged side by side in a left and right direction relative to a traveling direction of the train or arranged to be partially or entirely overlapped with each other in a vertical direction.

6. An information transmission system comprising:
the onboard system according to claim 2; and
a ground system including M types of track antennae selected from N types of track antennae with different resonance frequencies, N being larger than M, M being equal to or larger than 2, the M types of track antennae being arranged side by side in a left and right direction relative to a traveling direction of the train or arranged to be partially or entirely overlapped with each other in a vertical direction.
